(19) United States
(12) Patent Application Publication
(10) Pub. No.: US 2020/0382043 A1
(43) Pub. Date: Dec. 3, 2020

(54) DRIVE CONTROL DEVICE AND MOTOR DEVICE

(71) Applicant: NIDEC SERVO CORPORATION, Kiryu-shi (JP)

(72) Inventor: Masatomo ISHIKAWA, Kiryu-shi (JP)

(21) Appl. No.: 16/888,942

(22) Filed: Jun. 1, 2020

(30) Foreign Application Priority Data
Jun. 3, 2019 (JP) 2019-103636

(51) Int. Cl. H02P 29/024

(52) U.S. Cl. CPC H02P 29/027

(57) ABSTRACT

A drive control device for a motor that is driven by an inverter, the drive control device including a control circuit. The control circuit includes a variable gain amplifier that outputs a first voltage value indicating a current value acquired from the inverter, a comparator that compares the first voltage value acquired from the variable gain amplifier and a reference voltage value, and an overcurrent detection processor that stops driving the motor when the first voltage value exceeds the reference voltage value as a result of comparison by the comparator.

### CROSS REFERENCE TO RELATED APPLICATION

The present application claims priority under 35 U.S.C. § 119 to Japanese Application No. 2019-103636 filed on Jun. 3, 2019 the entire contents of which are hereby incorporated herein by reference.

### 1. FIELD OF THE INVENTION

The present disclosure relates to a drive control device and a motor device.

### 2. BACKGROUND

In order to safely drive a motor, research and development of a safety device that stops the motor when an overcurrent condition occurs has been underway.

In view of this, in a usage environment where safety is more important from among various usage environments of a motor, measures for safety have been demanded, such as installing multiple safety devices as described above, or providing a self-diagnosis function for determining whether the safety devices are normal or abnormal.

In this regard, a drive control device, for a motor, configured as described below has been known. Specifically, the drive control device includes a control circuit provided with a comparison unit that compares a reference voltage value and a first voltage value which increases or decreases according to a current value acquired from an inverter unit of the motor, and an arithmetic processing unit that determines whether or not an overcurrent occurs based on the comparison result of the comparison unit, wherein the arithmetic processing unit includes: a first terminal to which the comparison result of the comparison unit is input; an overcurrent detection processing unit which determines that an overcurrent state occurs when the first voltage value exceeds the reference voltage value in the comparison result, and stops the driving of the motor; a second terminal that receives the first voltage value and repeatedly outputs an operation check signal to the comparison unit at a preset timing; and an operation check processing unit that determines the state of the first terminal based on an output timing of the operation check signal.

In such a drive control device, a current detection unit, the comparison unit, and the arithmetic processing unit are separately provided. Therefore, it may be difficult to reduce the number of components in the drive control device. As a result, the manufacturing cost of the drive control device may not be reduced.

### SUMMARY

An example embodiment of the present disclosure provides a drive control device for a motor that is driven by an inverter, the drive control device including a control circuit. The control circuit includes a variable gain amplifier to output a first voltage value indicating a current value acquired from the inverter, a comparator to compare the first voltage value acquired from the variable gain amplifier and a reference voltage value, and an overcurrent detection processor to stop driving the motor when the first voltage value exceeds the reference voltage value as a result of comparison by the comparator.

Another example embodiment of the present disclosure provides a motor device including the motor and the drive control device described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram showing an example of a configuration of a drive control device 1 according to an example embodiment of the present disclosure.

FIG. 2 is a diagram showing an example of a configuration of a control circuit 4.

FIG. 3 is a diagram showing an example of operation timings of a current value detection processor 450, an overcurrent detection processor 452, and a first operation check processor 453 in a controller 45.

FIG. 4 is a diagram showing an example of an operation flow of the control circuit 4 when a motor 9 is driven.

FIG. 5 is a diagram showing an example of an operation flow of the first operation check processor 453 during a first determination process.

FIG. 6 is a diagram showing another example of the configuration of the control circuit 4.

FIG. 7 is a diagram showing an example of an operation flow of a second operation check processor 454 during a second determination process.

### DETAILED DESCRIPTION

Example embodiments of the present disclosure will be described below with reference to the drawings. In the present example embodiment, a conductor that transmits an electric signal will be referred to as a transmission path. The transmission path may be, for example, a conductor printed on a substrate, or a conductive wire such as a linearly formed conductor.

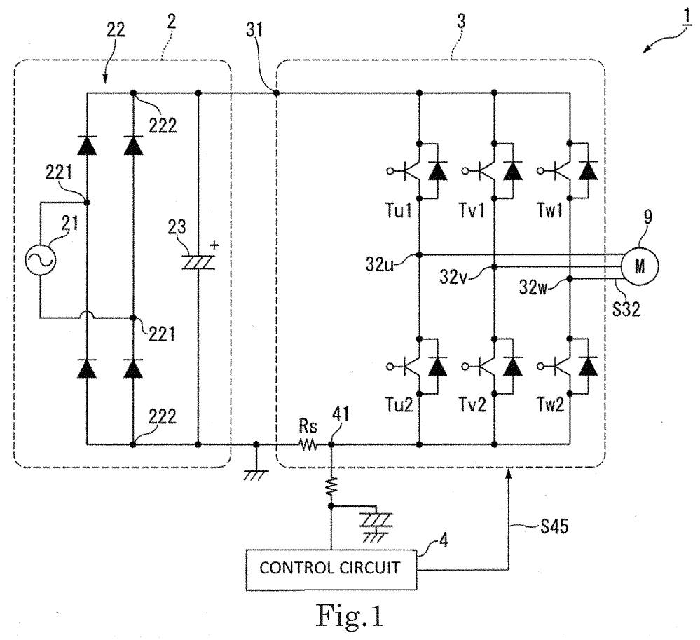

First, a configuration of a drive control device 1 according to the example embodiment will be described with reference to FIG. 1. FIG. 1 is a diagram showing an example of the configuration of the drive control device 1 according to the example embodiment.

The drive control device 1 supplies a drive current S32 to a motor 9. Thus, the drive control device 1 controls the drive of the motor 9.

The motor 9 is, for example, a motor that operates a blower of a bathroom dryer. The motor 9 may be another motor mounted on a product other than the bathroom dryer, instead of the motor that operates the blower of the bathroom dryer.

The motor 9 is, for example, a three-phase brushless DC (direct current) motor. That is, the motor 9 has U-phase, V-phase, and W-phase stator windings. When the drive current S32 is supplied to the stator winding of each phase, torque is generated in the motor 9 between the stator and the rotor, so that the rotor is rotationally driven. The motor 9 may be another motor driven by an inverter, such as a single-phase motor or a brushed motor.

As shown in FIG. 1, the drive control device 1 includes a power supply unit 2, an inverter 3, and a control circuit 4. The drive control device 1 may include other circuits and other devices in addition to the above components. Further, the drive control device 1 may be configured separately from at least one of the power supply unit 2 and the inverter 3. That is, the drive control device 1 may not include at least one of the power supply unit 2 and the inverter 3.

The power supply unit 2 includes an AC power supply 21, a diode bridge 22, and a smoothing capacitor 23.

Any power supply may be used for the AC power supply 21, as long as it supplies an AC voltage. The AC power supply 21 is, for example, a commercial power supply, but may be another external power supply device. The AC power supply 21 outputs an AC voltage to the diode bridge 22.

The diode bridge 22 is a full-wave rectifier circuit having four diodes. The diode bridge 22 has two input terminals 221. An AC voltage is supplied between these two input terminals 221 from the AC power supply 21. The AC voltage supplied between the two input terminals 221 is subjected to full-wave rectification in the diode bridge 22. The voltage after the full-wave rectification is a full-wave rectified voltage having a voltage waveform of only a positive voltage. This full-wave rectified voltage is output between two output terminals 222 of the diode bridge 22.

The smoothing capacitor 23 smooths the full-wave rectified voltage that has been subjected to full-wave rectification in the diode bridge 22. Thus, the smoothing capacitor 23 converts the full-wave rectified voltage into a DC voltage Vbus. Then, the DC voltage Vbus is output to a voltage input terminal 31 of the inverter 3.

The inverter 3 supplies the drive current S32 to the motor 9 according to a pulse signal S45 input from the control circuit 4. The inverter 3 has the voltage input terminal 31, six switching elements, a shunt resistor Rs, and three motor connection terminals.

The six switching elements included in the inverter 3 include a switching element Tu1, a switching element Tu2, a switching element Tv1, a switching element Tv2, a switching element Tw1, and a switching element Tw2. Each of the six switching elements includes a transistor and a diode which are connected in parallel. For example, an IGBT (insulated gate bipolar transistor) or the like is used as the transistor, but the transistor is not limited thereto.

Two switching elements, switching element Tu1 and switching element Tu2, are connected in series between the voltage input terminal 31 and the shunt resistor Rs. Further, two switching elements, switching element Tv1 and switching element Tv2, are also connected in series between the voltage input terminal 31 and the shunt resistor Rs. Further, two switching elements, switching element Tw1 and switching element Tw2, are also connected in series between the voltage input terminal 31 and the shunt resistor Rs. The combination of the switching element Tu1 and the switching element Tu2, the combination of the switching element Tv1 and the switching element Tv2, and the combination of the switching element Tw1 and the switching element Tw2 are connected in parallel with each other.

The shunt resistor Rs has one end connected to each of the switching element Tu2, the switching element Tv2, and the switching element Tw2, and has the other end grounded. A bus current Ibus flows from the inverter 3 to the shunt resistor Rs when the motor 9 is driven.

The three motor connection terminals of the inverter 3 include a motor connection terminal 32u, a motor connection terminal 32v, and a motor connection terminal 32w. The motor connection terminal 32u is located on a transmission path connecting the switching element Tu1 and the switching element Tu2. The motor connection terminal 32v is located on a transmission path connecting the switching element Tv1 and the switching element Tv2. The motor connection terminal 32w is located on a transmission path connecting the switching elements Tw1 and Tw2.

With the configuration described above, in the U phase of the inverter 3, the pulse signal S45 is input to each of a base terminal of the switching element Tu1 and a base terminal of the switching element Tu2, when the motor 9 is driven. In the V phase of the inverter 3, the pulse signal S45 is input to each of a base terminal of the switching element Tv1 and a base terminal of the switching element Tv2, when the motor 9 is driven. In the W phase of the inverter 3, the pulse signal S45 is input to each of a base terminal of the switching element Tw1 and a base terminal of the switching element Tw2, when the motor 9 is driven. Accordingly, ON/OFF of each of the six switching elements is switched. As a result, the drive current S32 is input to the U, V, and W phases of the motor 9 from the three motor connection terminals, respectively.

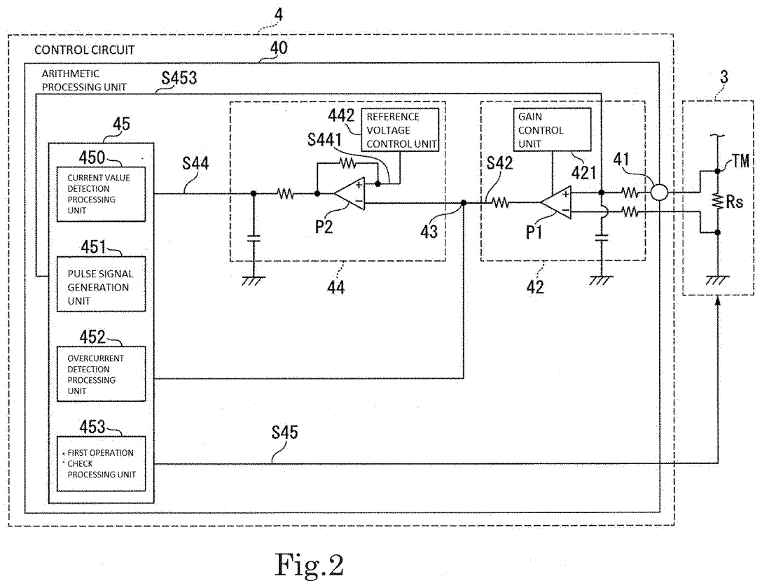

The control circuit 4 monitors the bus current Ibus of the motor 9 and controls the inverter 3. FIG. 2 is a diagram illustrating an example of the configuration of the control circuit 4. As shown in FIG. 2, the control circuit 4 includes, for example, an arithmetic processor 40.

The arithmetic processor 40 is, for example, a microcomputer. Note that the arithmetic processor 40 may be a random logic circuit such as an ASIC (application specific integrated circuit).

The arithmetic processor 40 includes a connection terminal 41, a current detection unit 42, a comparison-unit input terminal 43, a comparator 44, and a control unit 45.

The connection terminal 41 is one of a plurality of input/output terminals of the arithmetic processor 40. The connection terminal 41 is connected to a shunt voltage terminal TM. The shunt voltage terminal TM is located on a transmission path that connects the three switching elements Tu2, Tv2, and Tw2 of the inverter 3 and the shunt resistor Rs. When the bus current Ibus flows through the shunt resistor Rs, the voltage value of the shunt voltage terminal TM becomes the shunt voltage Vs that increases or decreases according to the current value of the bus current Ibus. That is, in this case, the shunt voltage Vs is supplied to the connection terminal 41.

The current detection unit 42 is an amplifier circuit that amplifies the shunt voltage Vs input to the connection terminal 41. As shown in FIG. 2, the current detection unit 42 is a differential amplifier circuit including a variable gain amplifier P1 and a plurality of resistors.

The variable gain amplifier P1 is, for example, a programmable gain amplifier. Note that the variable gain amplifier P1 may be another amplifier capable of changing a gain for amplifying the shunt voltage Vs, instead of the programmable gain amplifier.

The non-inverting input terminal of the variable gain amplifier P1 is connected to the connection terminal 41 via a resistor. The inverting input terminal of the variable gain amplifier P1 is grounded via a resistor. Therefore, a first voltage value S42 proportional to the voltage difference between the shunt voltage Vs and the ground voltage is output to the output terminal of the current detection unit 42.

Further, the current detection unit 42 has a gain controller 421.

The gain controller 421 sets the gain received by the arithmetic processor 40 from a user to the variable gain amplifier P1. That is, the gain for amplifying the shunt voltage Vs by the variable gain amplifier P1 is the gain set by the gain controller 421.

The comparison-unit input terminal 43 is an output terminal of the current detection unit 42. The comparison-unit input terminal 43 is also an input terminal of the comparator 44. The first voltage value S42 output from the current detection unit 42 is input to the comparator 44 via the comparison-unit input terminal 43. The comparison-unit input terminal 43 is also connected to a first terminal (not shown) of the control unit 45. Therefore, the first voltage value S42 output from the current detection unit 42 is also input to the control unit 45 via the comparison-unit input terminal 43.

The comparator 44 is a comparison circuit having a comparator P2. The comparator 44 has a reference voltage controller 442 that inputs a fixed reference voltage value S441 to the non-inverting input terminal of the comparator P2. The reference voltage controller 442 outputs the voltage value received by the arithmetic processor 40 from the user to the non-inverting input terminal of the comparator P2 as the reference voltage value S441. Thus, the drive control device can use the voltage desired by the user as the reference voltage.

Meanwhile, the inverting input terminal of the comparator P2 is connected to the comparison-unit input terminal 43. Therefore, when the first voltage value S42 from the current detection unit 42 is input to the comparison-unit input terminal 43, the comparator P2 compares the reference voltage value S441 with the first voltage value S42. Then, the comparator P2 outputs a voltage value corresponding to the magnitude relationship between the two input voltage values from an output terminal (not shown).

The output terminal of the comparator 44 is connected to a second terminal (not shown) of the control unit 45. Therefore, a determination voltage S44 indicating the comparison result by the comparator 44 is input to the second terminal. Specifically, when the first voltage value S42 is smaller than the reference voltage value S441, the determination voltage S44 is at an H (High) level. In addition, when the first voltage value S42 is equal to or higher than the reference voltage value S441, the determination voltage S44 is at an L (Low) level smaller than the H level.

The control unit 45 is, for example, a CPU (central processor). Note that the control unit 45 may be another processor instead of the CPU.

The control unit 45 controls the operation of the six switching elements of the inverter 3. The control unit 45 outputs the pulse signal S45 to the inverter 3 based on a motor drive command signal input from the outside, the first voltage value S42 input from the first terminal of the control unit 45, and the determination voltage S44 input from the second terminal of the control unit 45.

The control unit 45 periodically outputs a first operation check signal S453 to the non-inverting input terminal of the variable gain amplifier P1 from a third terminal (not shown) at a preset timing. Thus, the first operation check signal S453 is input to the variable gain amplifier P1.

Here, the control unit 45 can output at least two signals having different voltage values from the third terminal of the control unit 45 as the first operation check signal S453. Specifically, the control unit 45 outputs two types of signals, a signal at an allowable level having a voltage value lower than the reference voltage value S441, and a signal at an overcurrent equivalent level having a voltage value higher than the reference voltage value S441, from the third terminal of the control unit 45.

Further, the control unit 45 includes, for example, a current value detection processor 450, a pulse signal generation unit 451, an overcurrent detection processor 452, and a first operation check processor 453. These functional units of the control unit 45 are implemented by the control unit 45 performing arithmetic processing according to a preset program. Note that the control unit 45 may include other functional units in addition to these functional units. Further, the control unit 45 may have either the current value detection processor 450 or the pulse signal generation unit 451 or may not include both of them. In this case, the functional unit not included in the control unit 45 out of the current value detection processor 450 and the pulse signal generation unit 451 is implemented by a processor separate from the control unit 45.

The current value detection processor 450 acquires the first voltage value S42 input to the first terminal of the control unit 45 from the current detection unit 42. The current value detection processor 450 detects the current value of the bus current Ibus based on the acquired first voltage value S42. The first voltage value S42 is acquired in synchronization with the pulse signal S45.

The pulse signal generation unit 451 outputs the pulse signal S45 to the inverter 3 based on the motor drive command signal (not shown) input from the outside and the current value of the bus current Ibus detected by the current value detection processor 450.

The overcurrent detection processor 452 performs a monitoring process for monitoring whether or not an overcurrent occurs. More specifically, the overcurrent detection processor 452 performs, as the monitoring process, a process of detecting that the motor 9 is in the overcurrent state based on the comparison result of the comparator 44. The motor 9 being in the overcurrent state means that the current value of the bus current Ibus of the motor 9 is abnormally high. In other words, the motor 9 being in the overcurrent state means that the current value of the bus current Ibus of the motor 9 is higher than a predetermined value (that is, abnormally high). The predetermined value is a value determined according to a current value of the bus current Ibus of the motor 9 at which a failure or the like due to the bus current Ibus of the motor 9 starts to occur. The predetermined value is lower than this current value. In the example embodiment, the overcurrent detection processor 452 repeatedly performs the monitoring process while the first operation check processor 453 described later is not operating. Thus, the overcurrent detection processor 452 can constantly monitor whether or not an overcurrent occurs while the first operation check processor 453 is not operating.

In the monitoring process, the overcurrent detection processor 452 determines whether the determination voltage S44 from the comparator 44 input to the second terminal of the control unit 45 is at the L level or the H level. With this process, the overcurrent detection processor 452 determines whether or not the motor 9 is in the overcurrent state.

In the monitoring process, when determining that the determination voltage S44 is at the L level, the overcurrent detection processor 452 determines that the motor 9 is in the overcurrent state. Then, in this case, the overcurrent detection processor 452 stops outputting the pulse signal S45 from the pulse signal generation unit 451. Accordingly, in this case, the overcurrent detection processor 452 stops driving of the motor 9. That is, when determining that the motor 9 is in the overcurrent state, the overcurrent detection processor 452 stops driving of the motor 9.

On the other hand, in the monitoring process, the overcurrent detection processor 452 determines that the motor 9 is in a normal state, when determining that the determination voltage S44 is at the H level. Then, in this case, the overcurrent detection processor 452 does not stop the operation of the pulse signal generation unit 451. That is, in this case, the pulse signal generation unit 451 continues to output the pulse signal S45 to the inverter 3.

The first operation check processor 453 performs a first determination process of checking (determining) whether or not at least one of the current detection unit 42 and the comparator 44 is abnormal at a preset timing. More specifically, the first operation check processor 453 checks, at the timing, whether or not at least one of the variable gain amplifier P1 and the comparator P2 is abnormal in the first determination process. The first operation check processor 453 temporarily disables the monitoring process performed by the overcurrent detection processor 452 at the timing, outputs the first operation check signal S453 from the third terminal of the control unit 45, and executes the first determination process.

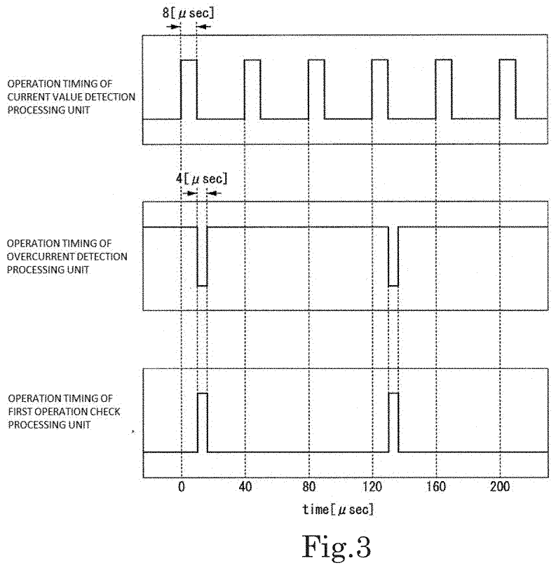

FIG. 3 is a diagram showing an example of operation timings of the current value detection processor 450, the overcurrent detection processor 452, and the first operation check processor 453 in the control unit 45. As shown in FIG. 3, the current value detection processor 450 executes a process of detecting the current value of the bus current Ibus at preset time intervals. In the example shown in FIG. 3, the cycle of the detection process of the current value detection processor 450 is 40 microseconds. In addition, the control unit 45 executes the first determination process by the first operation check processor 453 during a period when the detection process by the current value detection processor 450 is not executed. In the present example embodiment, the first determination process by the first operation check processor 453 is performed once while the detection process by the current value detection processor 450 is performed a plurality of times.

In addition, as shown in FIG. 3, the overcurrent detection processor 452 executes the monitoring process whenever the first determination process by the first operation check processor 453 is not performed. When executing the first determination process by the first operation check processor 453, the control unit 45 temporarily stops the monitoring process by the overcurrent detection processor 452.

As described above, in the drive control device 1 according to the example embodiment, the control circuit 4 is achieved by the arithmetic processor 40 which is implemented by one microcomputer. Therefore, the number of components constituting the control circuit 4 can be reduced in the drive control device 1. Note that, in the arithmetic processor 40, the control unit 45 may be implemented by one or more microcomputers. In this case, the arithmetic processor 40 includes a microcomputer, and the current detection unit 42 and the comparator 44 that are separate from the microcomputer. Also in this case, the arithmetic processor 40 uses the variable gain amplifier P1 instead of the operational amplifier in the current detection unit 42, so that the number of components such as resistors can be reduced in the arithmetic processor 40, compared with the case where the operational amplifier is used in the current detection unit 42. Further, since the variable gain amplifier P1 is used in the arithmetic processor 40 instead of the operational amplifier, the drive control device 1 can be applied to motors having various winding specifications without changing the configuration. That is, the drive control device 1 has a smaller number of components and can improve versatility. As a result, the manufacturing cost of the drive control device 1 can be reduced.

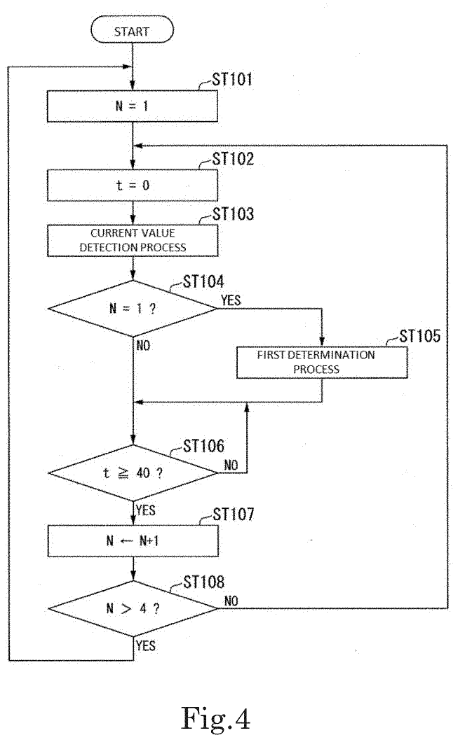

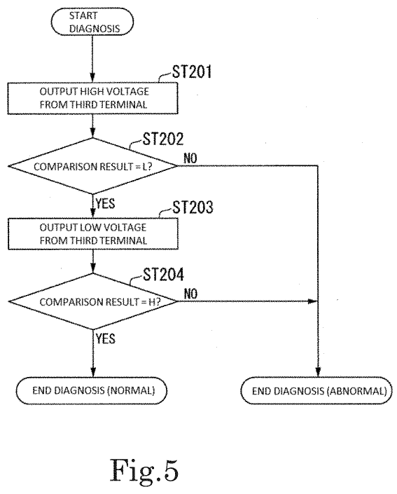

Next, the operation of the control circuit 4 will be described with reference to FIGS. 4 and 5. FIG. 4 is a diagram showing an example of an operation flow of the control circuit 4 when the motor 9 is driven. FIG. 5 is a diagram showing an example of an operation flow of the first operation check processor 453 during the first determination process.

The control circuit 4 determines whether or not an overcurrent occurs in the motor 9 using the current detection unit 42 and the comparator 44, which are electric circuits outside the control unit 45, and the control unit 45. During the detection of the overcurrent state using the electric circuit as described above, if short-to-power, ground-fault, or open state occurs due to the failure of the electric circuit, the overcurrent in the motor 9 may not be detected.

In view of this, the control circuit 4 outputs the first operation check signal S453 from the third terminal of the control unit 45, and performs the first determination process by the first operation check processor 453. Thus, the control circuit 4 determines whether or not a failure has occurred in the electric circuit part outside the control unit 45 of the control circuit 4. Specifically, the control circuit 4 determines whether or not a failure has occurred in at least one of the current detection unit 42 and the comparator 44 (that is, the electric circuit part). The control circuit 4 performs the current value detection process, the monitoring process, and the first determination process for checking the operation by the control circuit 4 when the motor 9 is driven, according to the following procedure.

As shown in FIG. 4, when the pulse signal generation unit 451 starts outputting the pulse signal S45 to the inverter 3, the control unit 45 resets a count number N to 1 (step ST101).

Next, the control unit 45 resets a time t to 0 (step ST102). The time t is incremented every 1 [microsecond]. Further, the processes in step ST101 and step ST102 may be performed in the reverse order, or may be performed in parallel.

When the setting of the count number N and the time t is completed, the current value detection processor 450 performs the process of detecting the current value of the bus current Ibus (step ST103). In step ST103, the current value detection processor 450 detects the current value of the bus current Ibus based on the first voltage value S42 input to the first terminal of the control unit 45. The detected current value of the bus current Ibus is used to generate the pulse signal S45 in the pulse signal generation unit 451.

In the present example embodiment, the process of detecting the current value of the bus current Ibus ends in about [microseconds]. After the end of step ST103, the control unit stops the detection process by the current value detection processor 450.

When the detection process in step ST103 ends, the control unit 45 determines whether or not the count number N is 1 (step ST104).

When the count number N is 1 (step ST104—YES), the control unit 45 causes the first operation check processor 453 to perform the first determination process (step ST105). The detailed procedure of the first determination process will be described later. In the present example embodiment, the first determination process ends in about 4 [microseconds]. The control unit 45 stops the process of detecting the current value of the bus current Ibus by the overcurrent detection processor 452 while the first determination process is being performed.

On the other hand, when the count number N is not 1 (step ST104—NO), the control unit 45 proceeds to step ST106 without performing the process in step ST105.

When the first determination process in step ST105 ends, or when the count number N is not 1 in step ST104, the control unit 45 determines whether the time t is equal to or greater than (step ST106). That is, the control unit 45 determines whether or not 40 [microseconds] have elapsed since the reset of the time t in step ST102.

When the time t is less than 40 (step ST106—NO), the control unit 45 returns to step ST106 and waits.

On the other hand, when the time t is equal to or greater than 40 (step ST106—YES), the control unit 45 increments the count number N (step ST107). Thereafter, the control unit 45 determines whether or not the count number N is greater than 4 (step ST108).

When determining that the count number N is equal to or less than 4 in step ST108 (step ST108—NO), the control unit 45 returns to step ST102. Then, the control unit 45 repeats the processes in steps ST102 to ST107. During the repeated processes, while the count number N is 2 to 4, the control unit 45 determines that the count number N is not 1 in step ST104, and thus the determination process in ST105 is skipped.

On the other hand, when determining in step ST108 that the count number N is greater than 4 (step ST108—YES), the control unit 45 returns to step ST101 and resets the count number N.

As described above, in the present example embodiment, the first determination process by the first operation check processor 453 is performed once while the detection process by the current value detection processor 450 is performed four times. However, the first determination process by the first operation check processor 453 may be performed once while the detection process performed by the current value detection processor 450 is performed one to three times, or while the detection process is performed five or more predetermined times. In order to reduce the load on the control unit 45, it is preferable to reduce the frequency of the first determination process as long as safety can be ensured.

Next, the first determination process by the first operation check processor 453 in step ST105 will be described with reference to FIG. 5. When ground-fault, short-to-power, or open state occurs due to the failure of the current detection unit 42, the first voltage value S42 acquired by the current value detection processor 450 does not change. Therefore, in this case, the control unit 45 can recognize an abnormality by the first determination process. In addition, if short-to-power occurs on the output terminal of the comparator 44 despite the current detection unit 42 being not in failure, the voltage input to the second terminal of the control unit 45 is at a level equal to or higher than the H level of the determination voltage S44. When ground-fault occurs on the output terminal of the comparator 44, the voltage input to the second terminal of the control unit 45 is at a level equal to or lower than the L level of the determination voltage S44. Further, when the output terminal of the comparator 44 is in the open state, the voltage input to the second terminal of the control unit 45 is undefined regardless of the voltage value input to the comparison-unit input terminal 43. For these reasons, when ground-fault, short-to-power, or open state occurs due to an occurrence of failure in the comparator 44, the control circuit 4 can recognize the abnormality by the first determination process.

In the first determination process, first, the first operation check processor 453 outputs the first operation check signal S453 at an overcurrent equivalent level having a voltage value higher than the reference voltage value S441 from the third terminal (step ST201). The first operation check signal S453 at the overcurrent equivalent level is input to the non-inverting input terminal of the variable gain amplifier P1. When the current detection unit 42 (that is, the variable gain amplifier P1) is normal and the comparator 44 is normal, the determination voltage S44 output from the comparator 44 is at the L level. The first operation check processor 453 determines whether or not the determination voltage S44 output from the comparator 44 has changed to the L level (step ST202).

In step ST202, when the determination voltage S44 output from the comparator 44 does not change to the L level (step ST202—NO), it is highly likely that short-to-power occurs in the comparator 44, the comparator 44 is in an open state, or the current detection unit 42 is in failure. Therefore, the first operation check processor 453 determines that at least one of the current detection unit 42 and the comparator 44 is abnormal, and ends the first determination process. Then, the first operation check processor 453 stops outputting the pulse signal S45 from the pulse signal generation unit 451 to the inverter 3.

On the other hand, when the determination voltage S44 output from the comparator 44 has changed to the L level (step ST202—YES) in step ST202, the first operation check processor 453 outputs the first operation check signal S453 at an allowable level having a voltage value lower than the reference voltage value S441 from the third terminal of the control unit 45 (ST203). The first operation check signal S453 at the allowable level is input to the non-inverting input terminal of the variable gain amplifier P1. When the variable gain amplifier P1 is normal, the variable gain amplifier P1 outputs the first voltage value S42 smaller than the reference voltage value S441. The first voltage value S42 is input to the comparison-unit input terminal 43. When the comparator 44 is normal, the determination voltage S44 output from the comparator 44 is at the H level. The first operation check processor 453 determines whether or not the determination voltage S44 output from the comparator 44 has changed to the H level (step ST204).

In step ST204, when the determination voltage S44 output from the comparator 44 does not change to the H level (step ST204—NO), it is highly likely that ground-fault occurs in the comparator 44, or the comparator 44 is in an open state. Therefore, the first operation check processor 453 determines that the comparator 44 is abnormal, and ends the determination process. Then, the first operation check processor 453 stops outputting the pulse signal S45 from the pulse signal generation unit 451 to the inverter 3.

On the other hand, in step ST204, when the determination voltage S44 output from the comparator 44 changes to the H level (step ST204—YES), it is determined that both the current detection unit 42 and the comparator 44 are normal, and the determination process ends.

As described above, the drive control device 1 according to the example embodiment can check whether or not both the current detection unit 42 and the comparator 44 for detecting an overcurrent are operating normally. Further, in the drive control device 1, the arithmetic processor 40 is implemented by one microcomputer. Therefore, the drive control device 1 enables reduction in the number of components.

In addition, in the drive control device 1 according to the example embodiment, the first operation check processor 453 performs the first determination process in a state where the detection process by the overcurrent detection processor 452 is stopped. Therefore, the driving of the motor 9 is not stopped by a high-voltage signal output from the first operation check processor 453 during the first determination process.

In the drive control device 1 according to the example embodiment, the process of detecting a current value by the current value detection processor 450 is performed at fixed time intervals, and the first operation check processor 453 performs the first determination process during the period when the detection process is not performed. Therefore, it is possible to check the operations of both the current detection unit 42 and the comparator 44 without reducing the operation frequency of the current value detection processor 450.

Further, in the drive control device 1 according to the example embodiment, the variable gain amplifier P1 serving as an amplifier and the comparator P2 included in the comparator are connected in series as shown in FIG. 2. With this configuration, the drive control device 1 can be configured to have a simpler circuit configuration, compared to a configuration in which the variable gain amplifier P1 and the comparator P2 are connected in parallel.

Hereinafter, a modification of the example embodiment will be described. In the modification of the example embodiment, the same components as those of the example embodiment are denoted by the same reference numerals, and the description thereof is omitted.

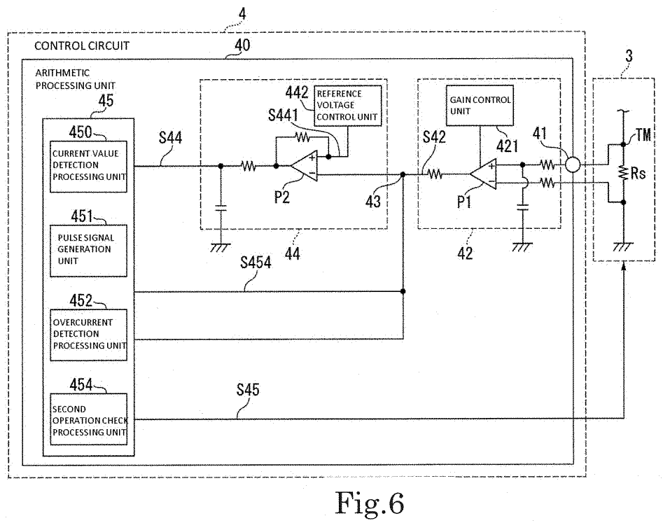

The control unit 45 described above may include a second operation check processor 454 instead of the first operation check processor 453 as shown in FIG. 6. FIG. 6 is a diagram illustrating another example of the configuration of the control circuit 4.

The second operation check processor 454 performs a second determination process of checking (determining) whether or not the comparator 44 is abnormal at a preset timing. More specifically, the second operation check processor 454 checks, at the timing, whether or not the comparator P2 is abnormal in the second determination process. The second operation check processor 454 temporarily disables the monitoring process of the overcurrent detection processor 452 at the timing, outputs a second operation check signal S454 to the inverting input terminal (the comparison-unit input terminal 43 in the example in FIG. 6) of the comparator P2 from a fourth terminal (not shown) of the control unit 45, and executes the second determination process. Note that the first terminal of the control unit 45 described above may serve as the fourth terminal.

The timing at which the second operation check processor 454 performs the second determination process is the same as the timing at which the first operation check processor 453 performs the first determination process. Therefore, the description of the timing at which the second operation check processor 454 performs the second determination processing is omitted.

In the drive control device 1 according to the modification of the example embodiment, the second operation check processor 454 performs the second determination process instead of the first determination process in step ST105 shown in FIG. 4.

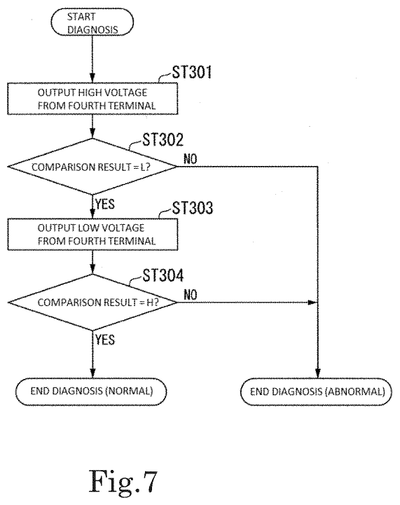

Here, the second determination process by the second operation check processor 454 will be described with reference to FIG. 7. FIG. 7 is a diagram showing an example of an operation flow of the second operation check processor 454 during the second determination process.

In the second determination process, first, the second operation check processor 454 outputs the second operation check signal S454 at an overcurrent equivalent level having a voltage value higher than the reference voltage value S441 from the fourth terminal (step ST301). The second operation check signal S454 at the overcurrent equivalent level is input to the inverting input terminal of the comparator P2. When the comparator 44 is normal, the determination voltage S44 output from the comparator 44 is at the L level. The second operation check processor 454 determines whether or not the determination voltage S44 output from the comparator 44 has changed to the L level (step ST302).

In step ST302, when the determination voltage S44 output from the comparator 44 does not change to the L level (step ST302—NO), it is highly likely that short-to-power occurs in the comparator 44, or the comparator 44 is in an open state. Therefore, the second operation check processor 454 determines that the comparator 44 is abnormal, and ends the second determination process. Then, the second operation check processor 454 stops outputting the pulse signal S45 from the pulse signal generation unit 451 to the inverter 3.

On the other hand, in step ST302, when the determination voltage S44 output from the comparator 44 has changed to the L level (step ST302—YES), the second operation check processor 454 outputs the second operation check signal S454 at an allowable level having a voltage value lower than the reference voltage value S441 from the fourth terminal of the control unit 45 (ST303). The second operation check signal S454 at the allowable level is input to the inverting input terminal of the comparator P2. When the comparator P2 is normal, the determination voltage S44 output from the comparator 44 is at the H level. The second operation check processor 454 determines whether or not the determination voltage S44 output from the comparator 44 has changed to the H level (step ST304).

In step ST304, when the determination voltage S44 output from the comparator 44 does not change to the H level (step ST304—NO), it is highly likely that ground-fault occurs in the comparator 44, or the comparator 44 is in an open state. Therefore, the second operation check processor 454 determines that the comparator 44 is abnormal, and ends the determination process. Then, the second operation check processor 454 stops outputting the pulse signal S45 from the pulse signal generation unit 451 to the inverter 3.

On the other hand, in step ST304, when the determination voltage S44 output from the comparator 44 changes to the H level (step ST304—YES), it is determined that the comparator 44 is normal, and the determination process ends.

As described above, the drive control device 1 according to the modification of the example embodiment can check whether or not the comparator 44 for detecting an overcurrent is operating normally. Further, in the drive control device 1, the arithmetic processor 40 is implemented by one microcomputer. Therefore, the drive control device 1 enables reduction in the number of components.

In the drive control device 1 described above, the control circuit 4 may include both the first operation check processor 453 and the second operation check processor 454. In this case, for example, the control unit 45 may perform the first determination process and the second determination process alternately or randomly in a predetermined sequence or at a timing determined by another method.

Further, the gain controller 421 described above may vary the gain of the variable gain amplifier P1 according to the shunt voltage Vs (that is, the magnitude of the value of the bus current Ibus flowing through the shunt resistor Rs) input to the arithmetic processor 40 via the connection terminal 41. Thus, the drive control device 1 can perform control such as increasing the gain when the value of the bus current Ibus is small, and decreasing the gain when the value of the bus current Ibus is large. As a result, the drive control device 1 can obtain a sufficiently large signal even when, for example, the bus current Ibus is small.

The drive control device 1 described above constitutes a motor device (not shown) together with the motor 9. The motor device may include other circuits and other devices in addition to the drive control device 1 and the motor 9.

Further, the first operation check processor 453 described above may sequentially output the first operation check signal S453 at the overcurrent equivalent level and the first operation check signal S453 at the allowable level continuously or intermittently.

As described above, the drive control device (the drive control device 1 in the example described above) according to the example embodiment is a drive control device for a motor (the motor in the example described above) driven by an inverter (the inverter 3 in the example described above), the drive control device including a control circuit (the control circuit 4 in the example described above), wherein the control circuit includes: a variable gain amplifier (the variable gain amplifier P1 in the example described above) that outputs a first voltage value indicating a current value acquired from the inverter; a comparator (the comparator 44 in the example described above) that compares the first voltage value acquired from the variable gain amplifier and a reference voltage value; and an overcurrent detection processor (the overcurrent detection processor 452 in the example described above) that stops driving of the motor, when the first voltage value exceeds the reference voltage value as a result of comparison by the comparator. Thus, the drive control device enables reduction in the number of components.

In the drive control device, the control circuit may include a first operation check processor (the first operation check processor 453) that outputs a first operation check signal (the first operation check signal S453 in the example described above) to the variable gain amplifier at a preset timing and that determines a state of the variable gain amplifier based on an output timing of the output first operation check signal.

In the drive control device, the control circuit may include a second operation check processor (the second operation check processor 454) that repeatedly outputs a second operation check signal (the second operation check signal S454 in the example described above) to the comparator at a preset timing, and that determines a state of the comparator based on an output timing of the output second operation check signal.

In the drive control device, the control circuit may include a gain controller (the gain controller 421 in the example described above) that varies a gain of the variable gain amplifier according to a magnitude of the current value.

In the drive control device, the control circuit may include a reference voltage controller (the reference voltage controller 442 in the example described above) that varies the reference voltage value set to the comparator according to a received operation.

In the drive control device, the control circuit may include an arithmetic processor, and the arithmetic processor may be provided with the variable gain amplifier, the comparator, and the overcurrent detection processor.

While the example embodiment of the present disclosure has been described above in detail with reference to the drawings, a specific configuration is not limited to the example embodiment, and various changes, substitutions, deletions, etc. may be possible without departing from the scope of the present disclosure.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A drive control device for a motor that is driven by an inverter, the drive control device comprising:
a control circuit including:
a variable gain amplifier to output a first voltage value indicating a current value acquired from the inverter;
a comparator to compare the first voltage value acquired from the variable gain amplifier and a reference voltage value; and
an overcurrent detection processor to stop driving the motor when the first voltage value exceeds the reference voltage value as a result of comparison by the comparator.

2. The drive control device according to claim 1, wherein the control circuit includes a first operation check processor to repeatedly output a first operation check signal to the variable gain amplifier at a preset timing, and determine a state of the variable gain amplifier based on an output timing of the output first operation check signal.

3. The drive control device according to claim 1, wherein the control circuit includes a second operation check processor to repeatedly output a second operation check signal to the comparator at a preset timing, and to determine a state of the comparator based on an output timing of the output second operation check signal.

4. The drive control device according to claim 1, wherein the control circuit includes a gain controller to vary a gain of the variable gain amplifier according to a magnitude of the current value.

5. The drive control device according to claim 1, wherein the control circuit includes a reference voltage controller to vary the reference voltage value set to the comparator according to a received operation.

6. The drive control device according to claim 1, wherein the control circuit includes an arithmetic processor provided with the variable gain amplifier, the comparator, and the overcurrent detection processor.

7. A motor device comprising:
the motor; and
the drive control device according to claim 1.

8. The drive control device according to claim 2, wherein the control circuit includes a second operation check processor to repeatedly output a second operation check signal to the comparator at a preset timing, and to determine a state of the comparator based on an output timing of the output second operation check signal.

9. The drive control device according to claim 2, wherein the control circuit includes a gain controller to vary a gain of the variable gain amplifier according to a magnitude of the current value.

10. The drive control device according to claim 3, wherein the control circuit includes a gain controller to vary a gain of the variable gain amplifier according to a magnitude of the current value.

11. The drive control device according to claim 2, wherein the control circuit includes a reference voltage controller to vary the reference voltage value set to the comparator according to a received operation.

12. The drive control device according to claim 3, wherein the control circuit includes a reference voltage controller to vary the reference voltage value set to the comparator according to a received operation.

13. The drive control device according to claim 4, wherein the control circuit includes a reference voltage controller to vary the reference voltage value set to the comparator according to a received operation.

14. The drive control device according to claim 2, wherein the control circuit includes an arithmetic processor provided with the variable gain amplifier, the comparator, and the overcurrent detection processor.

15. The drive control device according to claim 3, wherein the control circuit includes an arithmetic processor provided with the variable gain amplifier, the comparator, and the overcurrent detection processor.

16. The drive control device according to claim 4, wherein the control circuit includes an arithmetic processor provided with the variable gain amplifier, the comparator, and the overcurrent detection processor.

17. The drive control device according to claim 5, wherein the control circuit includes an arithmetic processor provided with the variable gain amplifier, the comparator, and the overcurrent detection processor.

18. A motor device comprising:
the motor; and
the drive control device according to claim 2.

19. A motor device comprising:
the motor; and
the drive control device according to claim 3.

20. A motor device comprising:
the motor; and
the drive control device according to claim 4.
